(19) United States
(12) Patent Application Publication
(10) Pub. No.: US 2026/0205596 A1
(43) Pub. Date: Jul. 16, 2026

(54) SUBBLOCK-BASED CROSS-COMPONENT PREDICTION

(71) Applicant: Tencent America LLC, Palo Alto, CA (US)

(72) Inventors: Lien-Fei CHEN, Palo Alto, CA (US); Yonguk YOON, Palo Alto, CA (US); Yifan WANG, Palo Alto, CA (US); Shan LIU, San Jose, CA (US); Roman CHERNYAK, Santa Clara, CA (US); Ziyue XIANG, Palo Alto, CA (US); Biao WANG, San Jose, CA (US)

(73) Assignee: Tencent America LLC, Palo Alto, CA (US)

(21) Appl. No.: 19/367,776

(22) Filed: Oct. 23, 2025

Related U.S. Application Data
(60) Provisional application No. 63/744,274, filed on Jan. 12, 2025.

(51) Int. Cl. H04N 19/132; H04N 19/176; H04N 19/186

(52) U.S. Cl. CPC H04N 19/132; H04N 19/176; H04N 19/186

(57) ABSTRACT

A video bitstream including coded information of a current block in a current picture of a video is received. The coded information indicates that a subblock-level cross-component model (CCM) is applied to the current block. A luma prediction block and a chroma prediction block for the current block are determined based on a prediction mode. The luma prediction block includes a plurality of luma prediction subblocks and the chroma prediction block includes a plurality of chroma prediction subblocks. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is reconstructed based on the first chroma prediction subblock, the subblock-level CCM, and the first luma prediction subblock.

### INCORPORATION BY REFERENCE

The present application claims the benefit of priority to U.S. Provisional Application No. 63/744,274, “SUBBLOCK-BASED CROSS-COMPONENT PREDICTION” filed on Jan. 12, 2025, which is incorporated by reference in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream including coded information of a current block in a current picture of a video is received. The coded information indicates that a subblock-level cross-component model (CCM) is applied to the current block. A luma prediction block and a chroma prediction block for the current block are determined based on a prediction mode. The luma prediction block includes a plurality of luma prediction subblocks and the chroma prediction block includes a plurality of chroma prediction subblocks. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is reconstructed based on the first chroma prediction subblock, the subblock-level CCM, and the first luma prediction subblock.

According to another aspect of the disclosure, a method of video encoding is provided. In the method, whether a subblock-level CCM is to be applied to a current block in a current picture of a video is determined. When the subblock-level CCM is determined to be applied to the current block, a luma prediction block and a chroma prediction block for the current block are determined based on a prediction mode. The luma prediction block includes a plurality of luma prediction subblocks and the chroma prediction block includes a plurality of chroma prediction subblocks. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is encoded into a bitstream based on the first chroma prediction subblock, the subblock-level CCM, and the first luma prediction subblock.

According to yet another aspect of the disclosure, a non-transitory computer-readable storage medium is provided. The non-transitory computer-readable storage medium stores instructions which when executed by a processor cause the processor to perform an encoding method. In the encoding method, whether a subblock-level CCM is to be applied to a current block in a current picture of a video is determined. When the subblock-level CCM is determined to be applied to the current block, a luma prediction block and a chroma prediction block for the current block are determined based on a prediction mode. The luma prediction block includes a plurality of luma prediction subblocks and the chroma prediction block includes a plurality of chroma prediction subblock. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is encoded into a bitstream based on the first chroma prediction subblock, the subblock-level CCM, and the first luma prediction subblock. The encoded bitstream is further transmitted.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods.

Technical solutions of the disclosure include methods and apparatuses related to subblock-based cross-component prediction (CCP) in which a cross-component filtering model is determined (e.g., derived) based on a prediction block and/or a reconstructed block of a luma component and a chroma component. In an example, a video bitstream including coded information of a current block in a current picture of a video is received. The coded information indicates that a subblock-level CCM is applied to the current block. A luma prediction block and a chroma prediction block for the current block are determined based on a prediction mode. The luma prediction block includes a plurality of luma prediction subblocks and the chroma prediction block includes a plurality of chroma prediction subblocks. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is reconstructed based on the first chroma prediction subblock, the subblock-level CCM, and the first luma prediction subblock. Therefore, coding efficiencies and accuracies of cross-component prediction are improved based on subblock-based cross-component prediction.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of a first example of a subblock-based cross-component model according to some aspects of the disclosure.

FIG. 5 is a schematic illustration of a second example of the subblock-based cross-component model according to some aspects of the disclosure.

FIG. 6 is a schematic illustration of a third example of the subblock-based cross-component model according to some aspects of the disclosure.

FIG. 7 is a schematic illustration of a fourth example of the subblock-based cross-component model according to some aspects of the disclosure.

FIG. 8 shows a flow chart outlining a decoding process according to some aspects of the disclosure.

FIG. 9 shows a flow chart outlining an encoding process according to some aspects of the disclosure.

FIG. 10 is a schematic illustration of a computer system in accordance with an aspect.

### DETAILED DESCRIPTION

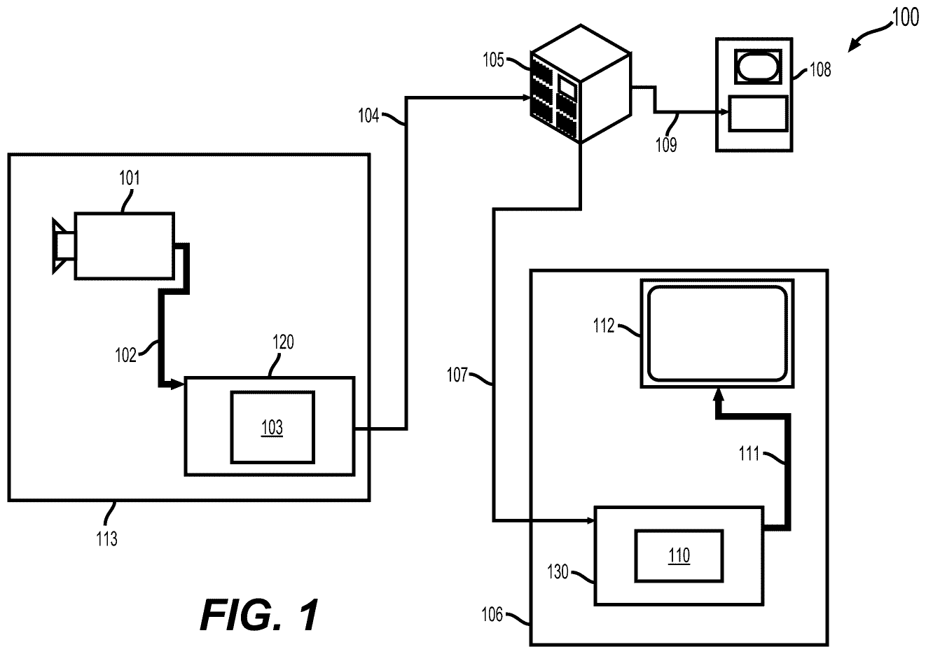

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

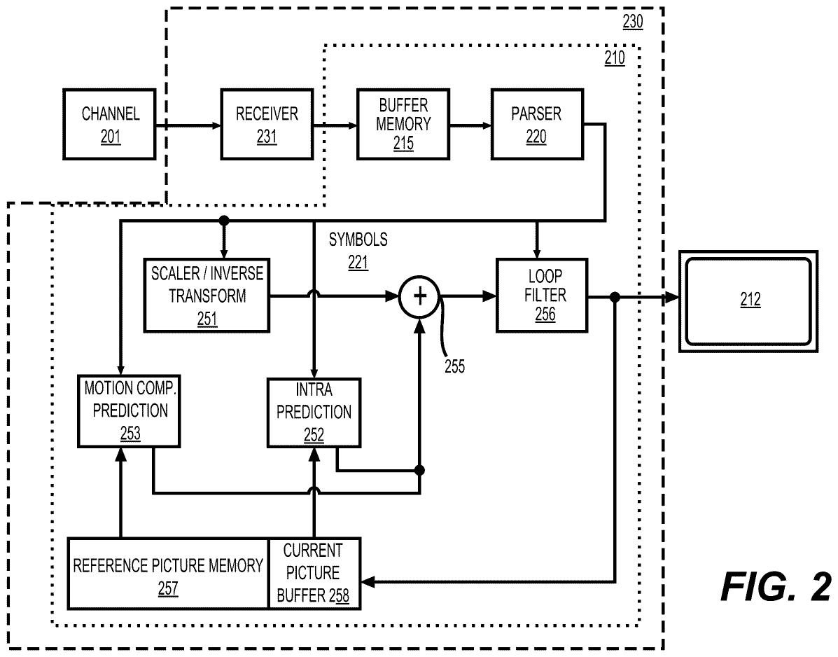

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example, megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

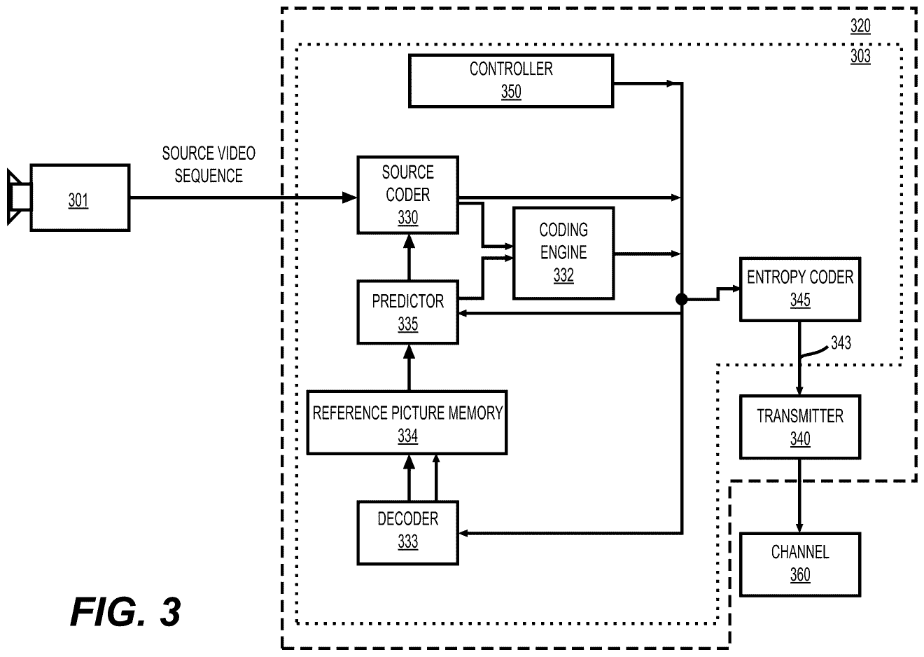

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for subblock-based cross-component prediction (CCP) when a cross-component model (CCM) is determined between a prediction block and/or a reconstructed block of a luma component and a chroma component.

Video coding has been widely used in many applications, such as broadcasting, video recording, and video streaming. Various emerging video coding standards, such as H.264, H.265/HEVC, H.266/VVC, and AV1 are published and widely adopted in these video applications. A hybrid video codec may include various coding modules, such as intra prediction, inter prediction, transform coding, quantization, entropy coding, and post in-loop filter.

Cross-component prediction is used in emerging video coding standards, such as VVC, AV1, AV2, and ECM. The cross-component prediction (or model) may be either determined (e.g., derived), for example, from (i) neighbouring reconstructed luma samples and chroma samples or (ii) a prediction block and/or a reconstructed coding block of a luma component and a chroma component.

In a related example, a cross-component model is determined from a prediction block of a luma component and a prediction block of a chroma component, and the determined model is applied to a reconstructed luma block to predict a chroma block. In other related examples, a cross-component model is determined from a reconstructed CTU block of a luma component and a reconstructed CTU block of a chroma component. The luma component and the chroma component are inputs of an adaptive loop-filter (ALF) to determine (e.g., derive) the cross-component model for a CTU block, and the determined model is applied to a luma CTU block after the ALF is applied either to improve an input signal of the CTU block for chroma ALF or to obtain an offset value for the CTU block after chroma ALF.

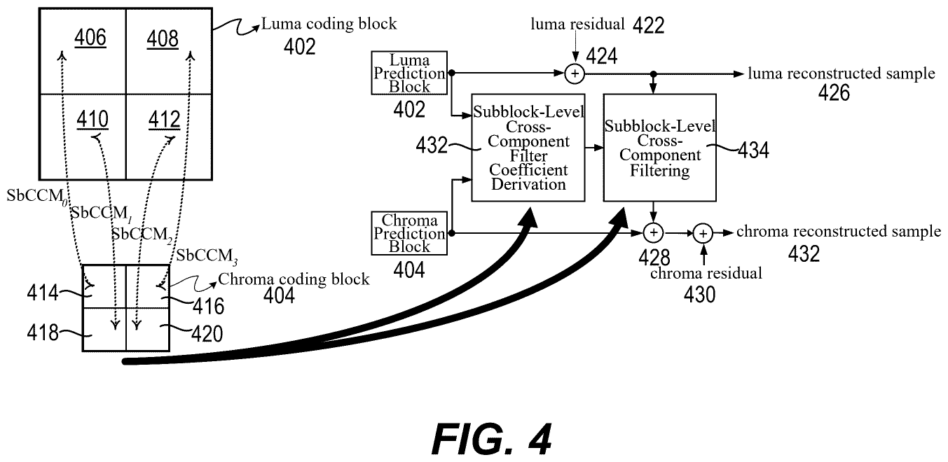

Aspects of the disclosure includes determining (e.g., deriving) a cross-component filtering model by using a subblock-based cross-component method to determine (e.g., derive) associated subblock cross-component models based on associated subblock predictions and/or reconstructed blocks. The associated subblock cross-component models are applied to associated reconstructed luma subblocks either to improve chroma samples in a subblock level or to obtain offset values at the subblock level. An example of the subblock-based cross-component method is shown in FIG. 4. In FIG. 4, four subblock-level cross-component models (CCMs) are determined (e.g., derived) from corresponding luma subblocks and chroma subblocks. The four determined (e.g., derived) subblock-level CCMs are applied to four luma subblocks to predict four chroma subblocks.

As shown in FIG. 4, a luma prediction block (or luma coding block) (402) and a chroma prediction block (or chroma coding block) (404) for a current block (not shown) are determined based on a prediction mode, such as an intra prediction mode or an inter prediction mode. The luma prediction block (402) includes a plurality of luma prediction subblocks, such as luma prediction subblocks (406), (408), (410), and (412). The chroma prediction block (404) includes a plurality of chroma prediction subblocks, such as chroma prediction subblocks (414), (416), (418), and (420). At step (432), a plurality of subblock-level cross-component models (SbCCMs) may be determined (e.g., derived) based on the luma prediction subblocks and the corresponding chroma subblocks. For example, a first subblock-level cross-component model SbCCM₀ is determined based on a first luma prediction subblock (406) and a first chroma prediction subblock (414) that corresponds to the first luma prediction subblock (406). A second subblock-level cross-component model SbCCM₁ is determined based on a second luma prediction subblock (408) and a second chroma prediction subblock (416) that corresponds to the second luma prediction subblock (408). In an example of FIG. 4, each of the SbCCMs corresponds to a respective subblock-level cross-component filter. Each subblock-level cross-component filter may include a plurality of filter coefficients.

In an example, to derive a cross-component model from luma samples and chroma samples, a linear relationship between the luma samples and co-located chroma samples may be determined, and the cross-component model is further applied to predict chroma from luma.

Still referring to FIG. 4, at step (424), a reconstructed luma block (or luma reconstructed samples) (426) may be determined based on the luma prediction block (402) and a luma residual (422). The reconstructed luma block may include a plurality of reconstructed luma subblocks that corresponds to the luma prediction subblocks. At step (434), the SbCCMs may be applied to the reconstructed luma subblocks to obtain a plurality of processed luma subblocks. For example, the SbCCM₀ is applied to a first reconstructed luma subblock to obtain a first processed luma subblock. At step (428), a fine-tuned chroma block is obtained based on a combination, such as a weighted combination, of the chroma prediction block (404) and the plurality of processed luma subblocks. A reconstructed chroma block (or chroma reconstructed samples) (432) may be obtained based on the fine-tuned chroma block and a chroma residual (430).

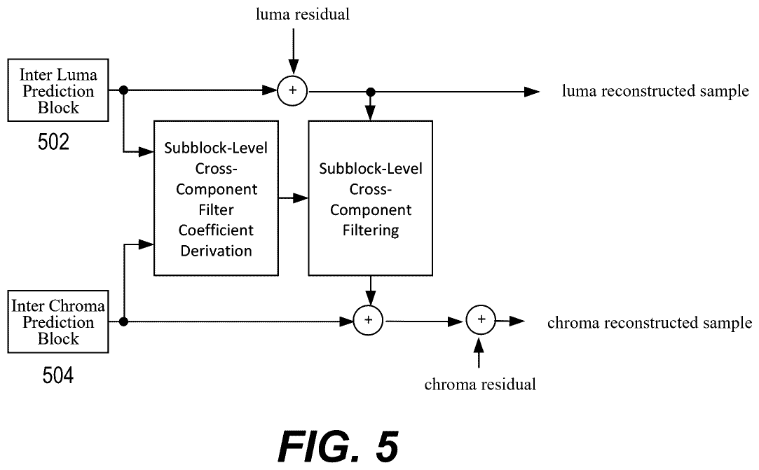

FIG. 5 shows an example of a subblock-based (or subblock-level) inter cross-component prediction. As shown in FIG. 5, an inter luma prediction block (502) and an inter chroma prediction block (504) are applied to determine (e.g., derive) the subblock-level CCMs.

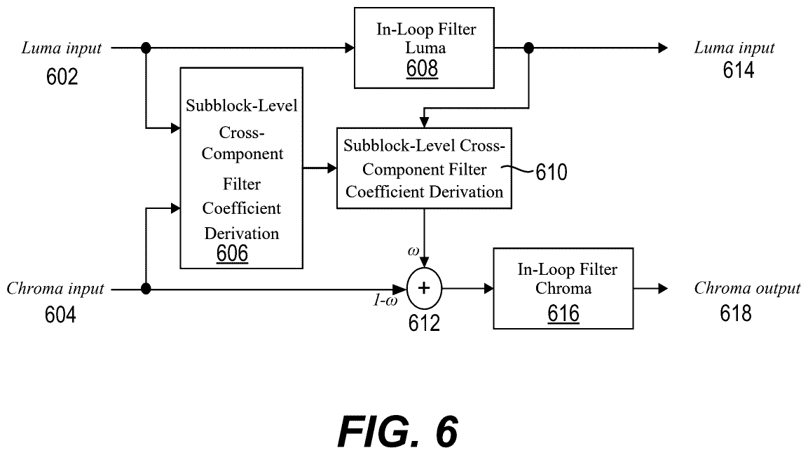

FIG. 6 shows an example of subblock-based cross-component prediction for in-loop filter input signal improvement. As shown in FIG. 6, a luma input (or luma prediction block) (602) and a chroma input (or chroma prediction block) (604) are determined based on a prediction mode. The luma input (602) may include a plurality of luma prediction subblocks and the chroma input (604) may include a plurality of chroma prediction subblocks. At step (606), a plurality of subblock-level cross-component models (SbCCMs) may be determined (e.g., derived) based on the luma prediction subblocks and the corresponding chroma subblocks. At step (608), a plurality of filtered luma subblocks are obtained by processing the luma prediction subblocks through an in-loop luma filter. In an example, the in-loop luma filter includes one of a deblocking filter, a sample adaptive offset (SAO) filter, an adaptive loop filter, or the like.

At step (610), the SbCCMs may be applied to the filtered luma subblocks to obtain a luma input (614) that indicates a plurality of processed luma subblocks. A reconstructed luma block may be determined based on the luma input and a luma residual. A plurality of fine-tuned chroma subblocks (612) may be obtained based on a weighted combination of the plurality of processed luma subblocks and the plurality of chroma prediction subblocks, according to a weight @. The plurality of fine-tuned chroma subblocks may further be filtered through an in-loop chroma filter to generate a chroma output (618). A plurality of reconstructed chroma subblocks may be determined based on the chroma output. For example, the reconstructed chroma subblocks may be obtained based on a combination of the chroma output and a chroma residual.

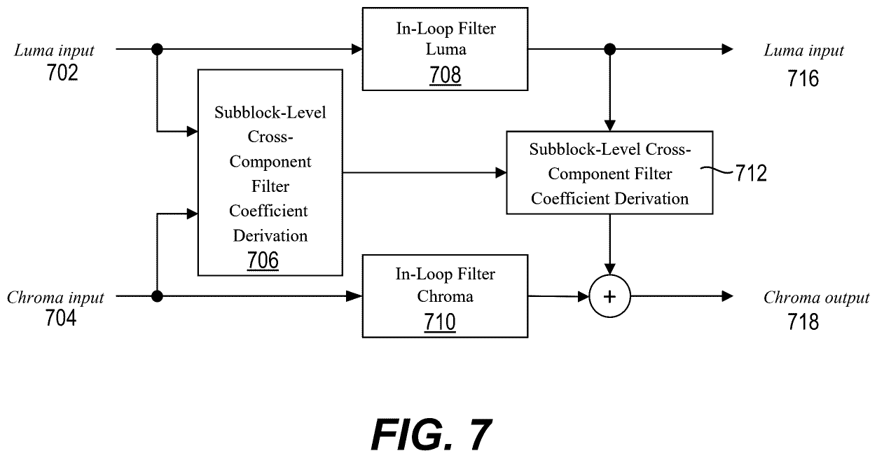

FIG. 7 shows an example of subblock-based cross-component offset prediction for in-loop-filter. As shown in FIG. 7, a luma input (or luma prediction block) (702) and a chroma input (or chroma prediction block) (704) are determined based on a prediction mode. The luma input (702) may include a plurality of luma prediction subblocks and the chroma input (704) may include a plurality of chroma prediction subblocks. At step (706), a plurality of subblock-level cross-component models (SbCCMs) may be determined (e.g., derived) based on the luma prediction subblocks and the corresponding chroma subblocks. At step (708), a luma input (716) is obtained by processing the luma prediction subblocks through an in-loop luma filter. The luma input (716) may include a plurality of filtered luma subblocks. At step (712), the SbCCMs may be applied to the filtered luma subblocks to obtain a plurality of processed luma subblocks. At step (710), a plurality of filtered chroma subblocks is obtained by processing the plurality of chroma prediction subblocks through an in-loop chroma filter. A chroma output (718) may be obtained based on a combination of the plurality of processed luma subblocks and the plurality of filtered chroma subblocks. A plurality of reconstructed chroma subblocks may be generated based on the chroma output. For example, the reconstructed chroma subblocks are determined based on the chroma output and a chroma residual.

In an aspect, a size of a subblock is equal to W/2ⁿ×H/2ⁿ, where W and H are a width and a height of a coding block (or CTU) respectively, and n is a non-negative integer value. In an example, the subblock is a luma prediction subblock (e.g., (406)), a chroma prediction subblock (e.g., (414)), a luma subblock of a coding block, or a chroma subblock of the coding block.

In an aspect, a subblock size is equal to a fixed rectangular block size. For example, the fixed rectangular block size includes one of 4×4, 8×8, 4×8, 8×4, 16×16, or the like.

In an example, the size of the rectangular block, or the fixed rectangular block size, varies according to a coding block size of a coding block.

In an aspect, a subblock size for a chroma component is determined by a chroma sampling in a picture format. For example, the chroma subblock size is equal to

$$\frac{w}{2} \times \frac{h}{2} ,$$

when a luma subblock size is w×h and a picture color format, such as 4:2:0 format.

In an aspect, a luma sampling is applied to a luma subblock for a model (e.g., the subblock-level CCM) derivation and application.

In an aspect, a padding method is applied to a subblock boundary, such as a boundary between two chroma prediction subblocks or a boundary between two luma prediction blocks, for subblock-level cross-component model derivation and application.

In an aspect, padding is only applied to a boundary that is not only a subblock boundary but also a block (or CTU) boundary. Cross-subblock boundary samples (or samples across subblock boundaries) may be used when the cross-subblock boundary samples are samples within a coding block (or CTU).

In an aspect, a control flag is signaled to indicate whether the subblock-level CCM derivation is used or not. In an example, if the control flag is true, the subblock-level CCMs are determined (e.g., derived) and the models are applied at a subblock-level across an entire coding block (CB) or coding tree unit (CTU). Otherwise, if the control flag is not true, a conventional cross-component method, such as a block-level cross-component method, is applied.

In an aspect, the subblock-level CCM derivation is also applied to either an adjacent or a non-adjacent reconstructed block of a coding block to determine (e.g., derive) a cross-component prediction (CCP) merge model. For example, the SbCCMs determined in FIG. 4, may also be applied to adjacent blocks or non-adjacent blocks by using a merge mode. In an example, the determined SbCCMs may be applied to the adjacent blocks or the non-adjacent blocks directly. In an example, the determined SbCCMs may be merge candidates for the adjacent blocks or the non-adjacent blocks.

In an aspect, a blending method is applied at subblock boundaries to smooth block boundary artifacts caused by different model predictions.

In an example, for samples at a boundary of two subblocks, a final result (or processed result) of the cross-component prediction of the boundary samples is a blending result of the two cross-component models. For example, samples at the boundary between the luma prediction subblocks (406) and (410) may be processed based on SbCCM₀ and SbCCM₁ respectively. A final result for the samples at the subblock boundary is obtained, for example, based on equation (1) as follows:

$$P ( x , y ) = w ( distance ) \times {F}_{ccp 0} ( x , y ) + ( 1 - w ( distance ) ) \times {F}_{ccp 1} ( x , y ) \qquad Eq . ( 1 )$$

$$and$$

$$\{ \begin{matrix}w ( distance ) = 0 \text{.5} , & if distance = 0 \\ w ( distance ) = 1 , & if distance > τ ; τ is a constant number \\ 0.5 \leq w ( distance ) \leq 1 , & other distance\end{matrix}$$

where F_{ccp0}(x, y) and F_{ccp1}(x, y) are cross-component filter outputs at a position (x, y). For example, F_{ccp0}(x, y) is a result when SbCCM₀ is applied to a boundary sample at the position (x, y), and F_{ccp1}(x, y) is a result when SbCCM₁ is applied to the boundary sample at the position (x, y). w(distance) is a linear function of a distance between the sample position and the subblock boundary.

In an aspect, a coding block level or a CTU level syntax is signaled to indicate a filter shape and/or a filter type that is to be used for the subblock-level CCP model derivation and application.

In an example, the syntax is signaled to indicate a filter shape and/or a tap filter (e.g., a 4-tap filter, a 6-tap filter) that is to be used.

In an example, the syntax is signaled to indicate whether a multi-model feature is applied to a subblock or not. For example, each subblock may include two or more regions with different features. According to the multi-model feature, in each region, a respective SbCCM may be derived and applied. If the signal is true, a multi-model is used for all subblocks. Otherwise, a single-model is used for all subblocks.

In an aspect, a syntax is signaled to indicate whether one or a combination of above two signals (e.g., the syntax indicating the filter shape and/or the filter type, and the syntax indicating the multi-model) is used for all subblocks.

In an aspect, an intra template matching method is applied to a reconstructed region of a coding frame (e.g., a current frame) to find at least one reference block of a current block, such as from a plurality of candidate reference block. A subblock-based CCP model (or subblock-level CCM) is determined (e.g., derived) by using luma samples and chroma samples of the reference block.

In an example, a flag is signaled to indicate whether the intra template matching method is applied or not. If the flag is true, the CCP model is determined (e.g., derived) by using the luma samples and the chroma samples of the reference block that is determined based on the intra template matching method.

In an example, the CCP model is determined (e.g., derived) from the reference block with a smallest intra template matching cost. For example, a plurality of candidate reference blocks is determined at a reconstructed region of a coding frame. According to the intra template matching, a plurality of template matching costs is determined between a template of a current block and a template of each of the plurality of candidate reference blocks. The reference block is selected from the plurality of candidate reference blocks that corresponds to a minimum template matching cost.

In an example, a list is constructed when multiple reference blocks are available for the CCP model (or subblock-based CCM) derivation, and the list is constructed by using intra template matching costs in a predefined order, such as an ascending order. In a bitstream, an index is signaled to indicate which reference block during the intra template matching is selected for the subblock-based CCP model derivation.

In an aspect, a block-matching process is performed to find at least one patch in a reconstructed region of a coding picture by minimizing a cost between a reference block of a current block and the patch in the reconstructed region of the coding picture. The cost may be measured using, but is not limited to, a sum of absolute differences (SAD), a sum of absolute transformed difference (SATD), a sum of squared errors (SSE), a mean squared error (MSE), or similar metrics.

In an example, a plurality of candidate patches is determined in the reconstructed region of the coding picture. A cost is determined between the reference block of the current block and each of the candidate patches. A patch is selected from the candidate patches that corresponds to a minimum cost.

In an example, a flag is signaled to indicate whether the block-matching process is applied or not. If the flag is true, the CCP model (or the subblock-level CCM) is determined (e.g., derived) by using chroma samples and luma samples of a patch determined based on the block-matching process.

In an example, the CCP model is determined (e.g., derived) from the patch which has a minimum cost compared with a reference block during the block-matching process.

In an example, a list is constructed when multiple patches are available for the CCP model derivation. For example, the list is constructed by using block-matching costs in a predefined order, such as in an ascending order. In the bitstream, an index is signaled to indicate which patch during the block-matching process is selected for subblock-based CCP model derivation.

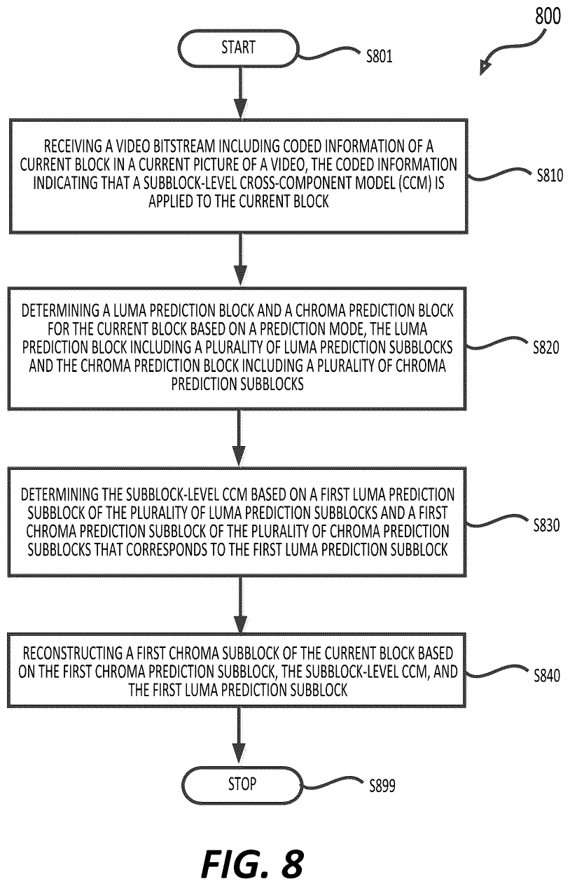

FIG. 8 shows a flow chart outlining a process (800) according to an aspect of the disclosure. The process (800) can be used in a video decoder. In various aspects, the process (800) is executed by processing circuitry, such as the processing circuitry that performs functions of the video decoder (110), the processing circuitry that performs functions of the video decoder (210), and the like. In some aspects, the process (800) is implemented in software instructions, thus when the processing circuitry executes the software instructions, the processing circuitry performs the process (800). The process starts at (S801) and proceeds to (S810).

At (S810), a video bitstream including coded information of a current block in a current picture of a video is received. The coded information indicates that a subblock-level CCM is applied to the current block.

At (S820), a luma prediction block and a chroma prediction block for the current block are determined based on a prediction mode. The luma prediction block includes a plurality of luma prediction subblocks and the chroma prediction block includes a plurality of chroma prediction subblocks.

At (S830), the subblock-level CCM is determined based on a first luma prediction subblock of the plurality of luma prediction subblocks and a first chroma prediction subblock of the plurality of chroma prediction subblocks that corresponds to the first luma prediction subblock.

At (S840), a first chroma subblock of the current block is reconstructed based on the first chroma prediction subblock, the subblock-level CCM, and the first luma prediction subblock.

In an aspect, a first reconstructed luma subblock of the current block is determined based on the first luma prediction subblock and a luma prediction residual. The subblock-level CCM is applied to the first reconstructed luma subblock to obtain a first processed luma subblock. A first reconstructed chroma subblock of the current block is determined based on the first processed luma subblock and a chroma prediction residual.

In an aspect, a first filtered luma subblock of the current block is determined by processing the first luma prediction subblock through an in-loop luma filter. The subblock-level CCM is applied to the first filtered luma subblock to obtain a first processed luma subblock. A first fine-tuned chroma subblock is determined based on a weighted combination of the first processed luma subblock and the first chroma prediction subblock. A first reconstructed chroma subblock of the current block is determined by processing the first fine-tuned chroma subblock through an in-loop chroma filter.

A first filtered luma subblock of the current block is determined by processing the first luma prediction subblock through an in-loop luma filter. The subblock-level CCM is applied to the first filtered luma subblock to obtain a first processed luma subblock. A first filtered chroma subblock of the current block is determined by processing the first chroma prediction subblock through an in-loop chroma filter. A first reconstructed chroma subblock of the current block is determined based on a combination of the first processed luma subblock and the first filtered chroma subblock.

In an aspect, the first chroma prediction subblock has a width of W₁/2ⁿ, and a height of H₁/2ⁿ. W₁ is a width of the chroma prediction block and H₁ is a height of the chroma prediction block. n is a non-negative integer. The first luma prediction subblock has a width of W₂/2ⁿ, and a height of H₂/2ⁿ. W₂ is a width of the luma prediction block and H₂ is a height of the luma prediction block

In an aspect, a width of the first chroma prediction subblock is defined based on a width of the first luma prediction subblock and a chroma sampling value. A height of the first chroma prediction subblock is defined based on a height of the first luma prediction subblock and the chroma sampling value.

In an aspect, sample padding is applied to a boundary of two luma prediction subblocks of the plurality of luma prediction subblocks when the boundary is a part of a boundary of the luma prediction block. In an aspect, samples positioned across the boundary of the two luma prediction subblocks are applied to determine the subblock-level CCM when the samples are within the luma prediction block.

In an aspect, the coded information includes a flag that indicates whether the subblock-level CCM is applied to the current block.

In an aspect, the subblock-level CCM is further applied to an adjacent block or a non-adjacent block of the current block when the adjacent block or the non-adjacent block is coded by a cross-component prediction merge model.

In an aspect, when a first sample of the first reconstructed luma subblock is positioned adjacent to a boundary of the first reconstructed luma subblock and a second reconstructed luma subblock of the current block, according to a weight, a first processed sample of the first processed luma subblock is determined based on a weighted combination of a first processed value obtained by applying the subblock-level CCM to the first sample and a second processed value obtained by applying another subblock-level CCM to the first sample. The other subblock-level CCM is determined based on the second reconstructed luma subblock.

In an aspect, the weight is defined based on a distance of the first sample to the boundary between the first reconstructed luma subblock and the second reconstructed luma subblock.

In an aspect, a filter shape or a filter type of a filter that is applied to determine the subblock-level CCM is determined according to a syntax element in the video bitstream.

In an aspect, the syntax element further indicates whether a multi-model feature is applied to determine the subblock-level CCM. The multi-model feature indicates that a different filter is determined based on a different region of the first luma prediction subblock or a different region of the first chroma prediction subblock.

In an aspect, a plurality of candidate reference blocks of the current block is determined. A cost value between a template of each of the plurality of candidate reference blocks and a template of the current block is determined. A reference block is determined from the plurality of candidate reference blocks that corresponds to a minimum cost value of the cost values. The luma prediction block and the chroma prediction block are determined from the reference block.

In an aspect, when a flag in the video bitstream indicates that an intra template matching is applied, a list of candidate reference blocks of the current block is determined in the current picture. The candidate reference blocks in the list are ordered according to cost values between templates of the candidate reference blocks in the list and a template of the current block. A reference block of the current block is determined from the list of candidate reference blocks based on a syntax element in the video bitstream. The syntax element indicates which one of the candidate reference blocks is selected as the reference block of the current block. The luma prediction block and the chroma prediction block are determined from the reference block.

In an aspect, a plurality of candidate patches of the current block is determined in a reconstructed region of the current picture. A cost value between each of the plurality of candidate patches and a reference block of the current block is determined. A patch is determined from the plurality of candidate patches that corresponds to a minimum cost value of the cost values. The luma prediction block and the chroma prediction block are determined from the patch.

In an aspect, when a flag in the video bitstream indicates that a block-matching process is applied, a list of candidate patches of the current block is determined in the current picture. The candidate patches in the list are ordered according to cost values between the candidate patches in the list and a reference block of the current block. A patch is determined from the list of candidate patches based on a syntax element in the video bitstream. The syntax element indicates which one of the candidate patches in the list is selected as the patch. The luma prediction block and the chroma prediction block are determined from the patch.

Then, the process proceeds to (S899) and terminates.

The process (800) can be suitably adapted. Step(s) in the process (800) can be modified and/or omitted. Additional step(s) can be added. Any suitable order of implementation can be used.

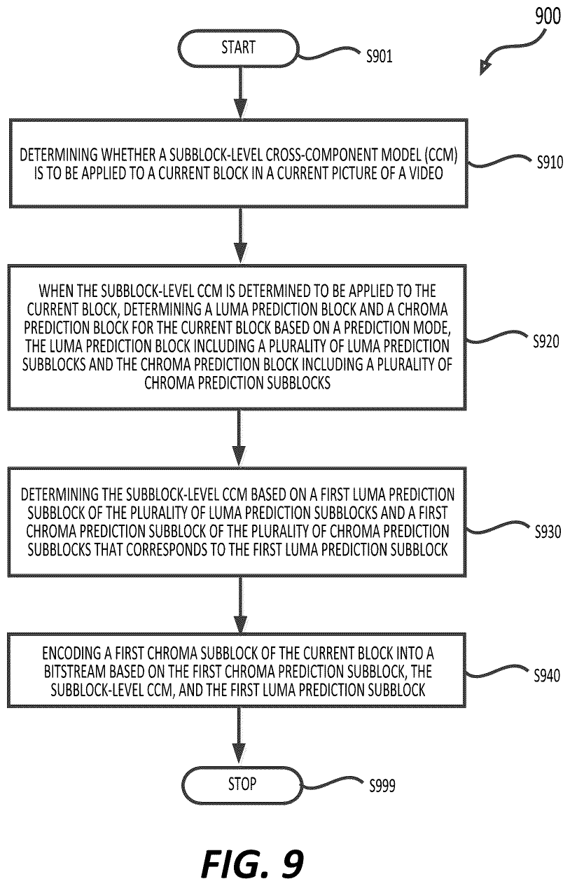

FIG. 9 shows a flow chart outlining a process (900) according to an aspect of the disclosure. The process (900) can be used in a video encoder. In various aspects, the process (900) is executed by processing circuitry, such as the processing circuitry that performs functions of the video encoder (103), the processing circuitry that performs functions of the video encoder (303), and the like. In some aspects, the process (900) is implemented in software instructions, thus when the processing circuitry executes the software instructions, the processing circuitry performs the process (900). The process starts at (S901) and proceeds to (S910).

At (S910), whether a subblock-level CCM is to be applied to a current block in a current picture of a video is determined.

At (S920), when the subblock-level CCM is determined to be applied to the current block, a luma prediction block and a chroma prediction block for the current block are determined based on a prediction mode. The luma prediction block includes a plurality of luma prediction subblocks and the chroma prediction block includes a plurality of chroma prediction subblocks.

At (S930), the subblock-level CCM is determined based on a first luma prediction subblock of the plurality of luma prediction subblocks and a first chroma prediction subblock of the plurality of chroma prediction subblocks that corresponds to the first luma prediction subblock.

At (S940), a first chroma subblock of the current block is encoded into a bitstream based on the first chroma prediction subblock, the subblock-level CCM, and the first luma prediction subblock.

Then, the process proceeds to (S999) and terminates.

The process (900) can be suitably adapted. Step(s) in the process (900) can be modified and/or omitted. Additional step(s) can be added. Any suitable order of implementation can be used.

In an aspect, a non-transitory computer-readable storage medium is provided. The non-transitory computer-readable storage medium stores instructions which when executed by a processor cause the processor to perform an encoding method. In the encoding method, whether a subblock-level CCM is to be applied to a current block in a current picture of a video is determined. When the subblock-level CCM is determined to be applied to the current block, a luma prediction block and a chroma prediction block for the current block are determined based on a prediction mode. The luma prediction block includes a plurality of luma prediction subblocks and the chroma prediction block includes a plurality of chroma prediction subblocks. The subblock-level CCM is determined based on a first luma prediction subblock of the plurality of luma prediction subblocks and a first chroma prediction subblock of the plurality of chroma prediction subblocks that corresponds to the first luma prediction subblock. A first chroma subblock of the current block is encoded into a bitstream based on the first chroma prediction subblock, the subblock-level CCM, and the first luma prediction subblock. The encoded bitstream is further transmitted.

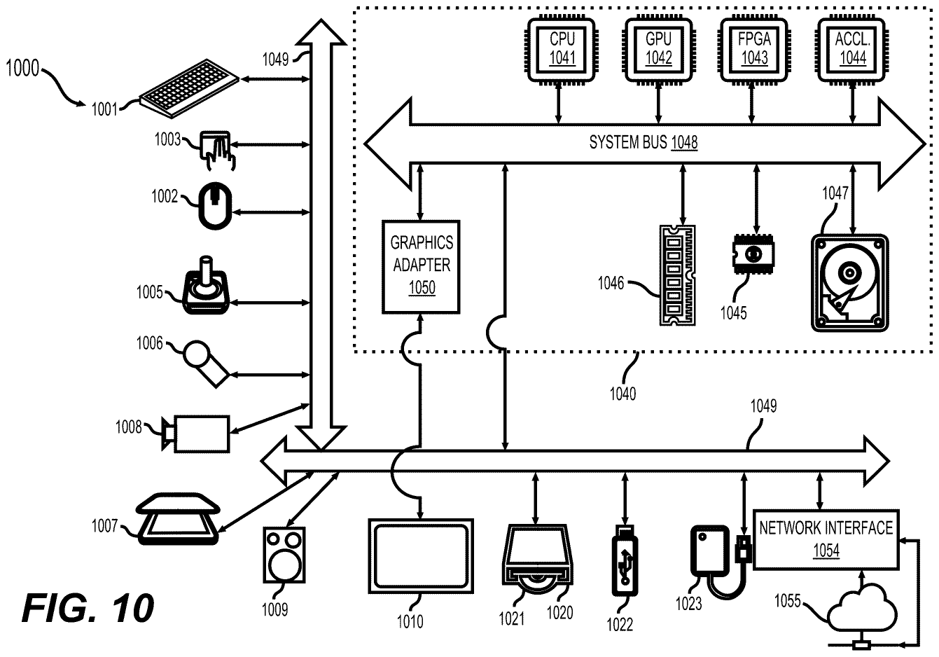

The techniques described above, can be implemented as computer software using computer-readable instructions and physically stored in one or more computer-readable media. For example, FIG. 10 shows a computer system (1000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (1000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there can also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1000) can also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) can also include an interface (1054) to one or more communication networks (1055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1040) of the computer system (1000).

The core (1040) can include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage such as internal non-user accessible hard drives, SSDs, and the like (1047), may be connected through a system bus (1048). In some computer systems, the system bus (1048) can be accessible in the form of one or more physical plugs to enable extensions by additional CPUs, GPU, and the like. The peripheral devices can be attached either directly to the core's system bus (1048), or through a peripheral bus (1049). In an example, the screen (1010) can be connected to the graphics adapter (1050). Architectures for a peripheral bus include PCI, USB, and the like.

CPUs (1041), GPUs (1042), FPGAs (1043), and accelerators (1044) can execute certain instructions that, in combination, can make up the aforementioned computer code. That computer code can be stored in ROM (1045) or RAM (1046). Transitional data can also be stored in RAM (1046), whereas permanent data can be stored for example, in the internal mass storage (1047). Fast storage and retrieve to any of the memory devices can be enabled through the use of cache memory, that can be closely associated with one or more CPU (1041), GPU (1042), mass storage (1047), ROM (1045), RAM (1046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1000), and specifically the core (1040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1040) that are of non-transitory nature, such as core-internal mass storage (1047) or ROM (1045). The software implementing various aspects of the present disclosure can be stored in such devices and executed by core (1040). A computer-readable medium can include one or more memory devices or chips, according to particular needs. The software can cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system can provide functionality as a result of logic hardwired or otherwise embodied in a circuit (for example: accelerator (1044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method of video decoding, including: receiving a video bitstream including coded information of a current block in a current picture of a video, the coded information indicating that a subblock-level cross-component model (CCM) is applied to the current block; determining a luma prediction block and a chroma prediction block for the current block based on a prediction mode, the luma prediction block including a plurality of luma prediction subblocks and the chroma prediction block including a plurality of chroma prediction subblocks; determining the subblock-level CCM based on a first luma prediction subblock of the plurality of luma prediction subblocks and a first chroma prediction subblock of the plurality of chroma prediction subblocks that corresponds to the first luma prediction subblock; and reconstructing a first chroma subblock of the current block based on the first chroma prediction subblock, the subblock-level CCM, and the first luma prediction subblock.
(2) The method of feature (1), in which the reconstructing further includes: determining a first reconstructed luma subblock of the current block based on the first luma prediction subblock and a luma prediction residual; applying the subblock-level CCM to the first reconstructed luma subblock to obtain a first processed luma subblock; and determining a first reconstructed chroma subblock of the current block based on the first processed luma subblock and a chroma prediction residual.
(3) The method of feature (1) or (2), in which the reconstructing further includes: determining a first filtered luma subblock of the current block by processing the first luma prediction subblock through an in-loop luma filter; applying the subblock-level CCM to the first filtered luma subblock to obtain a first processed luma subblock; determining a first fine-tuned chroma subblock based on a weighted combination of the first processed luma subblock and the first chroma prediction subblock; and determining a first reconstructed chroma subblock of the current block by processing the first fine-tuned chroma subblock through an in-loop chroma filter.
(4) The method of any one of features (1) to (3), in which the reconstructing further includes: determining a first filtered luma subblock of the current block by processing the first luma prediction subblock through an in-loop luma filter; applying the subblock-level CCM to the first filtered luma subblock to obtain a first processed luma subblock; determining a first filtered chroma subblock of the current block by processing the first chroma prediction subblock through an in-loop chroma filter; and determining a first reconstructed chroma subblock of the current block based on a combination of the first processed luma subblock and the first filtered chroma subblock.
(5) The method of any one of features (1) to (4), in which: the first chroma prediction subblock has a width of W₁/2ⁿ, and a height of H₁/2ⁿ, W₁ being a width of the chroma prediction block and H₁ being a height of the chroma prediction block, n being a non-negative integer; and the first luma prediction subblock has a width of W₂/2ⁿ, and a height of H₂/2ⁿ, W₂ being a width of the luma prediction block and H₂ being a height of the luma prediction block
(6) The method of any one of features (1) to (5), in which: a width of the first chroma prediction subblock is defined based on a width of the first luma prediction subblock and a chroma sampling value; and a height of the first chroma prediction subblock is defined based on a height of the first luma prediction subblock and the chroma sampling value.
(7) The method of any one of features (1) to (6), in which: sample padding is applied to a boundary of two luma prediction subblocks of the plurality of luma prediction subblocks when the boundary is a part of a boundary of the luma prediction block; and samples positioned across the boundary of the two luma prediction subblocks are applied to determine the subblock-level CCM when the samples are within the luma prediction block.
(8) The method of any one of features (1) to (7), in which the coded information includes a flag that indicates whether the subblock-level CCM is applied to the current block;
(9) The method of any one of features (1) to (8), in which the subblock-level CCM is further applied to an adjacent block or a non-adjacent block of the current block when the adjacent block or the non-adjacent block is coded by a cross-component prediction merge model.
(10) The method of feature (2), in which the applying the subblock-level CCM to the first reconstructed luma subblock further includes: when a first sample of the first reconstructed luma subblock is positioned adjacent to a boundary of the first reconstructed luma subblock and a second reconstructed luma subblock of the current block, determining, according to a weight, a first processed sample of the first processed luma subblock based on a weighted combination of a first processed value obtained by applying the subblock-level CCM to the first sample and a second processed value obtained by applying another subblock-level CCM to the first sample, the other subblock-level CCM being determined based on the second reconstructed luma subblock.
(11) The method of feature (10), in which the weight is defined based on a distance of the first sample to the boundary between the first reconstructed luma subblock and the second reconstructed luma subblock.
(12) The method of any one of features (1) to (11), in which the determining the subblock-level CCM further includes: determining a filter shape or a filter type of a filter that is applied to determine the subblock-level CCM according to a syntax element in the video bitstream.
(13) The method of feature (12), in which the syntax element further indicates whether a multi-model feature is applied to determine the subblock-level CCM, the multi-model feature indicating a different filter is determined based on a different region of the first luma prediction subblock or a different region of the first chroma prediction subblock.
(14) The method of any one of features (1) to (13), in which the determining the luma prediction block and the chroma prediction block further includes: determining a plurality of candidate reference blocks of the current block; determining a cost value between a template of each of the plurality of candidate reference blocks and a template of the current block; determining a reference block from the plurality of candidate reference blocks that corresponds to a minimum cost value of the cost values; and determining the luma prediction block and the chroma prediction block from the reference block.
(15) The method of any one of features (1) to (14), in which the determining the luma prediction block and the chroma prediction block further includes: when a flag in the video bitstream indicates that an intra template matching is applied, determining a list of candidate reference blocks of the current block in the current picture, the candidate reference blocks in the list being ordered according to cost values between templates of the candidate reference blocks in the list and a template of the current block; determining a reference block of the current block from the list of candidate reference blocks based on a syntax element in the video bitstream, the syntax element indicating which one of the candidate reference blocks is selected as the reference block of the current block; and determining the luma prediction block and the chroma prediction block from the reference block.
(16) The method of any one of features (1) to (15), in which the determining the luma prediction block and the chroma prediction block further includes: determining a plurality of candidate patches of the current block in a reconstructed region of the current picture; determining a cost value between each of the plurality of candidate patches and a reference block of the current block; determining a patch from the plurality of candidate patches that corresponds to a minimum cost value of the cost values; and determining the luma prediction block and the chroma prediction block from the patch.
(17) The method of any one of features (1) to (16), in which the determining the luma prediction block and the chroma prediction block further includes: when a flag in the video bitstream indicates that a block-matching process is applied, determining a list of candidate patches of the current block in the current picture, the candidate patches in the list being ordered according to cost values between the candidate patches in the list and a reference block of the current block; determining a patch from the list of candidate patches based on a syntax element in the video bitstream, the syntax element indicating which one of the candidate patches in the list is selected as the patch; and determining the luma prediction block and the chroma prediction block from the patch.
(18) A method of video encoding, includes: determining whether a subblock-level cross-component model (CCM) is to be applied to a current block in a current picture of a video; when the subblock-level CCM is determined to be applied to the current block, determining a luma prediction block and a chroma prediction block for the current block based on a prediction mode, the luma prediction block including a plurality of luma prediction subblocks and the chroma prediction block including a plurality of chroma prediction subblocks; determining the subblock-level CCM based on a first luma prediction subblock of the plurality of luma prediction subblocks and a first chroma prediction subblock of the plurality of chroma prediction subblocks that corresponds to the first luma prediction subblock; and encoding a first chroma subblock of the current block into a bitstream based on the first chroma prediction subblock, the subblock-level CCM, and the first luma prediction subblock.
(19) The method of feature (18), in which the encoding includes: determining a first reconstructed luma subblock of the current block based on the first luma prediction subblock and a luma prediction residual; applying the subblock-level CCM to the first reconstructed luma subblock to obtain a first processed luma subblock; and encoding the first chroma subblock of the current block based on the first processed luma subblock and a chroma prediction residual.
(20) A non-transitory computer-readable storage medium storing instructions which when executed by a processor cause the processor to perform an encoding method comprising: determining whether a subblock-level cross-component model (CCM) is to be applied to a current block in a current picture of a video; when the subblock-level CCM is determined to be applied to the current block, determining a luma prediction block and a chroma prediction block for the current block based on a prediction mode, the luma prediction block including a plurality of luma prediction subblocks and the chroma prediction block including a plurality of chroma prediction subblocks; determining the subblock-level CCM based on a first luma prediction subblock of the plurality of luma prediction subblocks and a first chroma prediction subblock of the plurality of chroma prediction subblocks that corresponds to the first luma prediction subblock; encoding a first chroma subblock of the current block into a bitstream based on the first chroma prediction subblock, the subblock-level CCM, and the first luma prediction subblock; and transmitting the encoded bitstream.
(21) An apparatus for video decoding, including processing circuitry that is configured to perform the method of any of features (1) to (17).
(22) An apparatus for video encoding, including processing circuitry that is configured to perform the method of any of features (18) to (19).
(23) A non-transitory computer-readable storage medium storing instructions which when executed by at least one processor cause the at least one processor to perform the method of any of features (1) to (19).

What is claimed is:

1. A method of video decoding, comprising:
receiving a video bitstream including coded information of a current block in a current picture of a video, the coded information indicating that a subblock-level cross-component model (CCM) is applied to the current block;
determining a luma prediction block and a chroma prediction block for the current block based on a prediction mode, the luma prediction block including a plurality of luma prediction subblocks and the chroma prediction block including a plurality of chroma prediction subblocks;
determining the subblock-level CCM based on a first luma prediction subblock of the plurality of luma prediction subblocks and a first chroma prediction subblock of the plurality of chroma prediction subblocks that corresponds to the first luma prediction subblock; and
reconstructing a first chroma subblock of the current block based on the first chroma prediction subblock, the subblock-level CCM, and the first luma prediction subblock.

2. The method of claim 1, wherein the reconstructing further comprises:
determining a first reconstructed luma subblock of the current block based on the first luma prediction subblock and a luma prediction residual;
applying the subblock-level CCM to the first reconstructed luma subblock to obtain a first processed luma subblock; and
determining a first reconstructed chroma subblock of the current block based on the first processed luma subblock and a chroma prediction residual.

3. The method of claim 1, wherein the reconstructing further comprises:
determining a first filtered luma subblock of the current block by processing the first luma prediction subblock through an in-loop luma filter;
applying the subblock-level CCM to the first filtered luma subblock to obtain a first processed luma subblock;
determining a first fine-tuned chroma subblock based on a weighted combination of the first processed luma subblock and the first chroma prediction subblock; and
determining a first reconstructed chroma subblock of the current block by processing the first fine-tuned chroma subblock through an in-loop chroma filter.

4. The method of claim 1, wherein the reconstructing further comprises:
determining a first filtered luma subblock of the current block by processing the first luma prediction subblock through an in-loop luma filter;
applying the subblock-level CCM to the first filtered luma subblock to obtain a first processed luma subblock;
determining a first filtered chroma subblock of the current block by processing the first chroma prediction subblock through an in-loop chroma filter; and
determining a first reconstructed chroma subblock of the current block based on a combination of the first processed luma subblock and the first filtered chroma subblock.

5. The method of claim 1, wherein:
the first chroma prediction subblock has a width of W₁/2ⁿ, and a height of H₁/2ⁿ, W₁ being a width of the chroma prediction block and H₁ being a height of the chroma prediction block, n being a non-negative integer; and
the first luma prediction subblock has a width of W₂/2ⁿ, and a height of H₂/2ⁿ, W₂ being a width of the luma prediction block and H₂ being a height of the luma prediction block.

6. The method of claim 1, wherein:
a width of the first chroma prediction subblock is defined based on a width of the first luma prediction subblock and a chroma sampling value; and
a height of the first chroma prediction subblock is defined based on a height of the first luma prediction subblock and the chroma sampling value.

7. The method of claim 1, wherein:
sample padding is applied to a boundary of two luma prediction subblocks of the plurality of luma prediction subblocks when the boundary is a part of a boundary of the luma prediction block; and
samples positioned across the boundary of the two luma prediction subblocks are applied to determine the subblock-level CCM when the samples are within the luma prediction block.

8. The method of claim 1, wherein the coded information includes a flag that indicates whether the subblock-level CCM is applied to the current block.

9. The method of claim 1, wherein the subblock-level CCM is further applied to an adjacent block or a non-adjacent block of the current block when the adjacent block or the non-adjacent block is coded by a cross-component prediction merge model.

10. The method of claim 2, wherein the applying the subblock-level CCM to the first reconstructed luma subblock further comprises:
when a first sample of the first reconstructed luma subblock is positioned adjacent to a boundary of the first reconstructed luma subblock and a second reconstructed luma subblock of the current block,
determining, according to a weight, a first processed sample of the first processed luma subblock based on a weighted combination of a first processed value obtained by applying the subblock-level CCM to the first sample and a second processed value obtained by applying another subblock-level CCM to the first sample, the other subblock-level CCM being determined based on the second reconstructed luma subblock.

11. The method of claim 10, wherein the weight is defined based on a distance of the first sample to the boundary between the first reconstructed luma subblock and the second reconstructed luma subblock.

12. The method of claim 1, wherein the determining the subblock-level CCM further comprises:
determining a filter shape or a filter type of a filter that is applied to determine the subblock-level CCM according to a syntax element in the video bitstream.

13. The method of claim 12, wherein the syntax element further indicates whether a multi-model feature is applied to determine the subblock-level CCM, the multi-model feature indicating a different filter is determined based on a different region of the first luma prediction subblock or a different region of the first chroma prediction subblock.

14. The method of claim 1, wherein the determining the luma prediction block and the chroma prediction block further comprises:
determining a plurality of candidate reference blocks of the current block;
determining a cost value between a template of each of the plurality of candidate reference blocks and a template of the current block;
determining a reference block from the plurality of candidate reference blocks that corresponds to a minimum cost value of the cost values; and
determining the luma prediction block and the chroma prediction block from the reference block.

15. The method of claim 1, wherein the determining the luma prediction block and the chroma prediction block further comprises:
when a flag in the video bitstream indicates that an intra template matching is applied,
determining a list of candidate reference blocks of the current block in the current picture, the candidate reference blocks in the list being ordered according to cost values between templates of the candidate reference blocks in the list and a template of the current block;
determining a reference block of the current block from the list of candidate reference blocks based on a syntax element in the video bitstream, the syntax element indicating which one of the candidate reference blocks is selected as the reference block of the current block; and
determining the luma prediction block and the chroma prediction block from the reference block.

16. The method of claim 1, wherein the determining the luma prediction block and the chroma prediction block further comprises:
determining a plurality of candidate patches of the current block in a reconstructed region of the current picture;
determining a cost value between each of the plurality of candidate patches and a reference block of the current block;
determining a patch from the plurality of candidate patches that corresponds to a minimum cost value of the cost values; and
determining the luma prediction block and the chroma prediction block from the patch.

17. The method of claim 1, wherein the determining the luma prediction block and the chroma prediction block further comprises:
when a flag in the video bitstream indicates that a block-matching process is applied,
determining a list of candidate patches of the current block in the current picture, the candidate patches in the list being ordered according to cost values between the candidate patches in the list and a reference block of the current block;
determining a patch from the list of candidate patches based on a syntax element in the video bitstream, the syntax element indicating which one of the candidate patches in the list is selected as the patch; and
determining the luma prediction block and the chroma prediction block from the patch.

18. A method of video encoding, comprising:
determining whether a subblock-level cross-component model (CCM) is to be applied to a current block in a current picture of a video;
when the subblock-level CCM is determined to be applied to the current block, determining a luma prediction block and a chroma prediction block for the current block based on a prediction mode, the luma prediction block including a plurality of luma prediction subblocks and the chroma prediction block including a plurality of chroma prediction subblocks;
determining the subblock-level CCM based on a first luma prediction subblock of the plurality of luma prediction subblocks and a first chroma prediction subblock of the plurality of chroma prediction subblocks that corresponds to the first luma prediction subblock; and
encoding a first chroma subblock of the current block into a bitstream based on the first chroma prediction subblock, the subblock-level CCM, and the first luma prediction subblock.

19. The method of claim 18, wherein the encoding comprises:
determining a first reconstructed luma subblock of the current block based on the first luma prediction subblock and a luma prediction residual;
applying the subblock-level CCM to the first reconstructed luma subblock to obtain a first processed luma subblock; and
encoding the first chroma subblock of the current block based on the first processed luma subblock and a chroma prediction residual.

20. A non-transitory computer-readable storage medium storing instructions which when executed by a processor cause the processor to perform an encoding method comprising:
determining whether a subblock-level cross-component model (CCM) is to be applied to a current block in a current picture of a video;
when the subblock-level CCM is determined to be applied to the current block, determining a luma prediction block and a chroma prediction block for the current block based on a prediction mode, the luma prediction block including a plurality of luma prediction subblocks and the chroma prediction block including a plurality of chroma prediction subblocks;
determining the subblock-level CCM based on a first luma prediction subblock of the plurality of luma prediction subblocks and a first chroma prediction subblock of the plurality of chroma prediction subblocks that corresponds to the first luma prediction subblock;
encoding a first chroma subblock of the current block into a bitstream based on the first chroma prediction subblock, the subblock-level CCM, and the first luma prediction subblock; and
transmitting the encoded bitstream.
